(19) United States
(12) Patent Application Publication
(10) Pub. No.: US 2016/0162812 A1
(43) Pub. Date: Jun. 9, 2016

(54) SYSTEM AND METHOD FOR UTILIZING VIRTUAL AND REAL CURRENCIES FOR PROCESSING CRUISE AND CRUISE-RELATED TRANSACTIONS

(71) Applicant: INTERNATIONAL CRUISE & EXCURSION GALLERY, INC., Scottsdale, AZ (US)

(72) Inventors: John Roger ROWLEY, Scottsdale, AZ (US); Marcia Gene ROWLEY, Scottsdale, AZ (US)

(21) Appl. No.: 14/992,520

(22) Filed: Jan. 11, 2016

Related U.S. Application Data
(63) Continuation-in-part of application No. PCT/US2015/035042, filed on Jun. 10, 2015.
(60) Provisional application No. 62/089,002, filed on Dec. 8, 2014.

(51) Int. Cl. G06Q 10/02; G06Q 50/30; G06Q 20/38

(52) U.S. Cl. CPC G06Q 10/02; G06Q 20/381; G06Q 50/30

(57) ABSTRACT

Methodologies and apparatuses create and utilize member profiles and provide members the ability to combine their use of actual currency and virtual currency created by a cruise line using common virtual currency to obtain a cruise booking and/or related products and/or service available from a wide variety of vendors partnering with the cruise line. Further, the use of common virtual currency enables formulation, management, comparison and presentation of options for using virtual currency specific to cruise lines.

### CROSS-REFERENCE TO RELATED APPLICATION(S)

This application claims priority, as a Continuation-in-Part application, to International Application Serial No. PCT/US2015/035042, entitled “SYSTEM AND METHOD FOR UTILIZING VIRTUAL AND REAL CURRENCIES FOR PROCESSING TRANSACTIONS,” filed Jun. 10, 2015, and, thereby also claims priority to U.S. Provisional Application Ser. No. 62/089,002, entitled “SYSTEM AND METHOD FOR PROCESSING AND OPTIMIZING TRAVELER ACCOMMODATIONS,” filed on Dec. 8, 2014, the entire disclosures of each of which are incorporated herein by reference.

### FIELD

This application is directed to a system, components and processes for providing assistance to providers and purchasers of products offered by the travel industry, in particular cruise lines. The disclosed system and processes that provide a technically specific solution to (1) convert a variety of partner-specific points/loyalty program credits for users to a single virtual currency and (2) support transactions for users for services/products from various vendors/suppliers using a combination of the virtual currency and real currency.

### BACKGROUND

Conventional loyalty programs (e.g., frequent flyer clubs, credit card benefit packages, etc.) and vacation clubs offer financial benefits to members through consumer loyalty and engagement. Consumers participate in loyalty programs to obtain added benefits as a result of purchasing products and services on a repeated or periodic basis. Consumers buy vacation clubs for a number of different reasons. For example, a sense of ownership can provide a sense of belonging and deeper connection with a brand or community.

In both loyalty programs and vacation clubs, the perception of status, can be a driving factor as it relates to member privileges. The perceived value of such membership is based on the value provided by the overall benefits included in the program. However, flexibility and choice associated with a program are viewed as particularly valuable as well because they provide the member with the freedom to choose when, where and how often to access their benefits, e.g., selecting a vacation, purchasing products etc. Additionally, such programs can provide members with real and perceived levels of consistency in quality, value and service.

As a result, loyalty programs are very common through a broad range of industries. Likewise, various brands offer vacation clubs to their members. This is because such programs provide revenue opportunities from existing business, lock in repeat business. In particular, with regard to vacation clubs, programs enable their customers to pre-purchase future products, e.g., vacations that can only be used within the club's brand, leverage existing inventory sold to club members to increase sales and profits each year, leverage pre-committed inventory to base load versus less reliable group booking strategies, and increase yield because members can use pre-purchased points consistently over index on higher cabin categories, spend more onboard and book more frequently. This also provides the opportunity to strategically place bookings on ‘need’ dates/itineraries, rewarding the most loyal customers in opaque pricing configurations versus discounting in open market. As a result, in the present state of commerce, every major hotel brand offers a vacation club benefit program for their high value guests.

Thus, various conventional online services offer discounted retail prices on travel products including hotel accommodations, cruises, golf packages, etc. At least some of these services are based on private-branded, leisure-based membership, rewards, loyalty programs and benefits. Such services also can include cruise and vacation fulfillment services. Thus, such services leverage the value and appeal of vacation and lifestyle offerings to fulfill customer expectations, drive customer engagement and increase brand appeal.

Similarly, some conventional loyalty programs and vacation clubs offer virtual points or currencies to drive customer engagement and increase brand appeal. Thus, it is conventionally known to use sales and marketing programs that offer alternative currencies as a payment method toward travel/lifestyle bookings. However, these virtual or alternative currencies/points are only valuable in the context of the services that accept them. As a result, the value of these approaches and the reach of the resulting marketing and sales activities are limited to members who have access to those services.

Likewise, conventional “time share” services sell a particular form of ownership or use rights to a property, e.g., resort condominium unit, wherein multiple users have rights to use the property, and each user is allotted a period of time (typically one week and almost always the same time every year) in which they may use the property. Units may be on a partial ownership, lease, or “right to use” basis, in which the user holds no claim to ownership of the property. Many of these time share services utilize similar points or virtual currency systems to determine how the user can use their rights to either use the particular property for which they have a time share, or to trade that property right for use of another property. Indeed, time share services have conventionally provided complex systems for use and management of time share rights.

Users, also referred to in the industry as “sharers,” “members” or “owners” conventionally can exchange their use right, e.g., a week at a particular vacation property, either independently or through one of various exchange agencies, e.g., RCI® (formerly, Group RCI®; formerly Resort Condominiums International®), a division of the firm Wyndham Worldwide) and Interval International® (owned by Interval Leisure Group, Inc.), to stay at another resort. Each of those exchanges has resort affiliate programs. These exchanges charge a yearly membership fee and fees for when they find an exchange. However, members can only exchange with affiliate resorts.

Although owners can exchange their points without needing the resort to have a formal affiliation agreement with an exchange company, owners' options are quite limited. For example, owners may arrange a direct exchange with another owner. However, this requires locating an owner with the location and weeks both mutually desire. This form of exchange saves money on exchange fees. Various bulletin boards help timeshare owners meet other owners to perform timeshare exchange.

Nevertheless, the use right may have different forms; although the vast majority are one week of ownership—i.e., 1/52 year, some developers sell point-based systems that are a different form of vacation currency that allow hotel stays, car rentals, and stays at large networks of resorts.

The allure of exchanging these time share units, also referred to in the travel industry as “vacation ownership,” pushes sales regardless of the actual resort property for which ownership interest is purchased. However, the ability to exchange use rights is also limited based on the perceived value or attraction of a particular resort. For example, a resort property in Hawaii being perceived as more valuable or attractive than a resort property in Montana. Thus, the higher valued resort may exchange extremely well; however, the lower valued resort only exchanges subject to demand for that particular destination.

There has been conventionally recognized utility associated with enabling users to purchase goods or services using accumulated points held by a variety of award programs. See, for example, U.S. Pat. No. 8,600,807, entitled “Method and System for Electronic Exchange of Reward Points.” However, it has not been conventionally possible to appropriately value such points, credits and the like in such a system so as to enable perceived and actual member benefits while generating revenue for the organizations providing those programs and an organization operating an exchange for trading such points/credits. Moreover, it should be appreciated that “sharers,” “members” or “owners” OF resort time shares cannot effectively use their member benefits to conventionally purchase cruises, cruise-related services, such as shore excursions or the using their accumulated points or credits.

### SUMMARY

Disclosed embodiments of the inventive system and processes provide a technically specific solution to (1) convert a variety of partner-specific points/loyalty program credits for users to a single virtual currency and (2) support cruise and cruise-related transactions for users for services/products using a combination of the virtual currency and real currency. This inventive system utilizes what is referred to herein as a “Multi-Currency Transaction Processing” (MCTP) system.

Disclosed embodiments of the MCTP system provide a valuable channel for cruise lines to move product/service inventory without discounting while providing consumers/users with a unique and compelling value proposition.

The disclosed MCTP embodiments create and utilize member profiles and provide members the ability to combine their use of actual currency and virtual currency created by a travel partner using common virtual currency to obtain a product and/or service available from a cruise line. Further, the use of common virtual currency enables formulation, management, comparison and presentation of options for using virtual currency specific to cruise lines.

Further, disclosed embodiments may utilize a yield/pricing engine that dynamically sets a permitted mix of real and virtual currencies for a specific transaction. That permitted mix may be allocated per member, per member class, and/or per client associated with the member class. Disclosed embodiments may dynamically set the permitted mix based on a member's valuation and/or client value within the system and based on market conditions.

Disclosed MCTP embodiments enabler unique exchange clubs, loyalty programs, alternative currencies, packaged products and proprietary currency redemption platforms that produce preferred high quality bookings that are extremely compelling to cruise lines, travel agencies and cruisers alike.

Disclosed embodiments provide a completely opaque virtual currency program that incentivizes customers to book cruises and cruise-related excursions and upgrades with little or no market pricing disruption the cruise lines' other product offerings.

In accordance with at least one embodiment, the MCTP system can perform accelerated conversion of funded virtual currency, wherein an effect of the converted funded virtual currency on a transaction is based at least in part on an underlying value of a transaction to which the converted funded virtual currency are applied.

In accordance with at least one embodiment, the MCTP system can perform pre-issuance of an amount of the virtual currency, wherein an effect of the pre-issued virtual currency on a transaction can be based at least in part on an underlying value of a transaction to which the pre-issued amount of virtual currency are applied.

In accordance with at least one embodiment the MCTP system can reimburse a member for maintenance fees/member dues based on payment of the maintenance fees/member dues paid to another party, e.g., a time share organization. The reimbursement may be in the form of the virtual currency, wherein an effect of the virtual currency on a transaction is based at least in part on an underlying value of a transaction to which the virtual currency are applied.

### BRIEF DESCRIPTION OF THE DRAWINGS

FIG. 1 illustrates one example of the disclosed embodiments of the MCTP in relationship to partners and members utilizing the functionality of the system.

FIG. 2 illustrates another example of how the disclosed embodiments of the MCTP in relationship to organizations including partners, payment processers and facilitators and product/service providers.

FIGS. 3-4 illustrate examples of functionality for providing members with the ability to purchase product offering based on virtual currency/actual currency spent through the MCTP system of the disclosed embodiments.

FIGS. 5-11 illustrate various examples of screen shots associated with the front end of the MCTP system, and in particular, the yield/pricing engine and the offer generation module, providing offer related functionality.

### DETAILED DESCRIPTION

With the above understanding of the state of the loyalty rewards, timeshares and the commercial travel industry in mind, it should be understood that time share owners, loyalty program members, vacation club members and the like conventionally constitute a captive market of users with points, rights, or alternative/virtual currency to expend on travel industry and lifestyle products and services. Although the idea of being able to exchange such points, credits, etc. is known, there is no effective way to apply disparate virtual currencies to a common currency that can be combined with actual currency to purchase services and products at discounted prices. As a result, consumers' ability to use their points, credits etc., is limited to the offerings provided by the offerors of those programs/services. Thus, in the case of timeshares, these limitations create a large “bank account” of pre-sold vacation rights.

Accordingly, disclosed embodiments of the inventive system and processes provide a technically specific solution to (1) convert a variety of partner-specific points/loyalty program credits for users to a single virtual currency and (2) support transactions for users for services/products from various vendors/suppliers using a combination of the virtual currency and real currency. This inventive system is referred to herein as a “Multi-Currency Transaction Processing” (MCTP) system.

Disclosed embodiments of the MCTP system provide a valuable channel for travel and leisure suppliers to move product/service inventory without discounting while providing consumers/users with a unique and compelling value proposition.

The disclosed MCTP embodiments create and utilize member profiles and provide members the ability to combine their use of actual currency and virtual currency created by a travel partner using common virtual currency to obtain a product and/or service available from a wide variety of vendors. Further, the use of common virtual currency enables formulation, management, comparison and presentation of options for using virtual currency specific to travel partners.

Further, disclosed embodiments may utilize a yield/pricing engine that dynamically sets a permitted mix of real and virtual currencies for a specific transaction. That permitted mix may be allocated per member, per member class, and/or per client associated with the member class. Disclosed embodiments may dynamically set the permitted mix based on a member's valuation and/or client value within the system and based on market conditions.

In accordance with at least one embodiment, the MCTP system can perform accelerated conversion of funded points, wherein an effect of the converted funded points on a transaction can be based at least in part on an underlying value of a transaction to which the converted funded points are applied.

As used in this application “actual currency” means government or bank notes generally accepted as currency, such as dollars.

“Virtual currency” (e.g., virtual dollars) is a form of currency created by a MCTP system administrator that authorizes partners (i.e., clients) to distribute virtual currency to end-users that are members of an organization associated with the partner (e.g., a resort time share organization, loyalty program, private-branded payment or membership organization, leisure-based membership organization, reward program, etc.). Virtual currency may or may not have an expiration date. Virtual currency from different sources may vary in value. Accordingly, virtual currency is either system specific virtual currency for a particular partner (as it is created by a partner of the administrator) or common virtual currency for the MCTP system (as it is created by the administrator).

The term “member” refers to and includes a user purchasing a product and/or service using virtual currency and/or actual currency. The term “member” includes individuals purchasing a product and/or service using virtual currency and/or actual currency and who is by virtue of an agreement a member of the MCTP system operated by the administrator. For example, with regard to a cruise, the member may be an individual who has purchased a cruise with a particular cruise line and/or may belong to a vacation club, loyalty program or similar program associated with or operated by the cruise line or on its behalf.

The term “administrator” means the entity that creates and operates the MCTP computer system and programs for offering travel services and products.

Disclosed embodiments of the MCTP system are directed to methodologies and systems that improve a variety of existing award travel programs that offer a value in the form of a credit or points or similar value. Typically, these programs are limited in that the points or credits have expiration dates and/or the ability to use the value is limited to a specific program or programs associated with a particular travel partner, e.g., UNITED AIRLINES®. The presently disclosed embodiments provide members of these award travel programs an opportunity to trade their value in a specific program for value in a wide variety of cruise, hotel, rental and other travel options provided by a wider variety of travel partners.

Conventionally, a variety of travel, hotel and entertainment offerings are provided to the general public. These services (e.g., travel, hotel and entertainment) are operated or managed by many different travel, hotel and entertainment entities. These entities partner with the administrator of the present disclosed system so as to increase the utility and perceived value of these offering programs.

The presently disclosed MCTP system enables continuing contracts with these entities (partners) so that the virtual currencies of these entities (partner system specific virtual currencies) and the MTCP's common virtual currency may be utilized individually, together and with or without actual currency to purchase offerings provided by the partners and others. That is, the disclosed embodiments of the MCTP system provides a mechanism to pay for a product and service fully in cash, fully in MCTP system common virtual currency or the partner-specific virtual currency (for example, points on an airline), or allowing part cash and part virtual currency (whether that currency be partner-specific or MCTP system common currency). The MCTP system need not establish a gateway for a partner entity to distribute their virtual currency; rather, each partner may bring their own currency into the MCTP system, often at a price per point to do so.

Implementing disclosed embodiments provides various benefits to a cruise line including incremental financial opportunities and growth and a differential business advantage wherein members can use their virtual currency balances as part of purchasing cruises.

By creating an opaque distribution channel of pre-sold, virtual currency, cruise lines can utilize this channel for base loading, which focuses on selling inventory further from a cruise departure date by targeting sales and marketing tactics, such as full ship charters and corporate meetings which generate business with longer booking windows. Conventional base-loading strategies can also include strategic relationships with travel agencies and international tour operators, who commit to purchasing a certain level of inventory with long lead times. This enables cruise lines to effectively charge premium prices or promote private sales without lowering prices in the open retail market.

Disclosed embodiments enable cruise lines to base load more effectively because members can pre-purchase their next 2-5 cruises, and use the resulting virtual currency in a ‘bank’ at any time until expiration. Members who utilize virtual currency rather than cash spend more per transaction and repeat transactions more frequently. As a result, a cruise line can target market to a group of members and strategically fill targeted inventory to base load. Furthermore, the cruise line can incentivize early booking by creating more member value the earlier the customer books. Moreover, brands can also move distressed inventory by changing the value of virtual currency to direct customers to sailings that have greater need so as not to disrupt the retail pricing market.

Additionally, cruise lines may experience increased revenue per diem per member (i.e., ticket price and onboard spend by the member), new revenue opportunities from existing business, increased passenger engagement and enhanced communications, as well as unique sales and marketing opportunities provided in an opaque model, wherein virtual currency allows a cruise line to reward their most loyal customers with promotional opportunities in virtual currency versus conventional discounting practices that result in lowering of rates in an open retail marketplace.

Cruise lines also are provided utility via customer retention and a cohesive cruise line upgrade strategy that can generate cruise credits toward future cruise line cruises from margin on passengers' shoreside leisure activities, thereby increasing frequency of bookings.

The disclosed embodiments may perform rewards yielding by using the dynamic yield engine to rewards platforms to utilize the margin to fund a cash back reward that converts to virtual currency.

In this way, cruise lines need not reduce the selling cost of cruises to vacation club members. Rather, using the disclosed embodiments, cruise lines can yield more per cruise through the use of virtual currency because of the number of variables considered that contribute to the overall yield. As with all bookings, the underlying price may be determined by the cruise line at the time of booking. Points programs may, for example, result in unused or remnant virtual currency, which will either expire or may be combined with additional virtual currency purchases. In accordance with the disclosed embodiments, while the price per point may be locked in at the time of a club membership purchase, the underlying amount of virtual currency required for each cruise can remain variable and, optionally, controlled by the cruise line or the MCTP at the time of booking of the cruise.

The disclosed MCTP system embodiments enable consumers to purchase today for travel that would be booked in the future. This protocol provides numerous advantages including customer exclusivity, pricing opacity and bulk purchases. The amount of virtual currency required to book a vacation is derived from converting the underlying price of the vacation to the cash equivalent of virtual currency. This provides the supplier with unparalleled yield management flexibility. Further, participation of members in the program increases the members' balance of virtual currency leading to accelerated cruise bookings, upgraded cabin staterooms, increased onboard spend and overall base loading raising stateroom prices and the overall per diem per passenger.

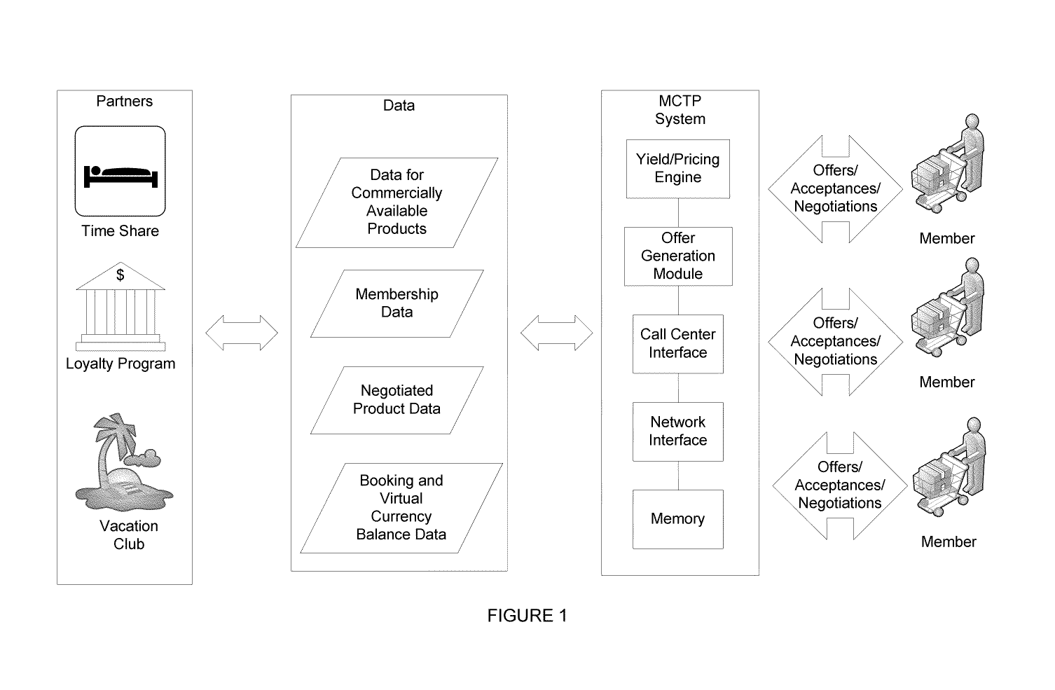

Thus, the disclosed MCTP system embodiments may include a computer system that maintains a current listing of products for sale beyond cruises (e.g., resort packages, travel, merchandise, wine etc.) to consumers. As shown in FIG. 1 the MCTP system may include a yielding/pricing engine, offer generation module, call center interface, network interface and one or more memory for storing computed code instructions and data for providing the functionality of the MCTP system described herein.

In order to provide this functionality, the MCTP system exchanges (i.e., receives and transmits data) with one or more partners that may include, for example, cruise line loyalty programs or vacation clubs, time share resorts, loyalty program organizations, etc. This may include data for commercially available products from the partners, membership data regarding members who have memberships with those partners, negotiated product data for analysis by the MCTP system and booking and virtual currency balance data, for example. These are merely examples of various information inputs, but are not intended as limiting. The number of information inputs is too extensive to list as should be evident from the present disclosure.

Additionally, the MCTP system may receive information from one or more feeds of information that provide data regarding commercially available products. By analyzing this information the yield/pricing engine and offer generation module cooperate to generate offers to members for members to use virtual and/or real currency to purchase products/services through the MCTP system. The yield/pricing engine and offer generation module also cooperate to analyze acceptances from members and process those acceptances so as to generate transactions, e.g., bookings and product purchases on behalf of the members. As part of this process, these components of the MCTP system may interact with one or more members and partners as part of a negotiation process on behalf of those entities.

The data for commercially available products may include merchandise and resort prices come from an internal database with prices set by the yield/pricing engine (which can be offset by use of virtual currency).

These communications may be supported or enabled by the network interface in the MCTP system that provides communication over one or more public and/or private communication networks including, for example, the Internet, intranets and telecommunications network(s). Additionally, the MCTP system includes a call center interface that enables the MCTP system to provide access to call center personnel for members' transaction facilitation; to that end, the call center interface may also include equipment and software that enable the call center personnel to access member, transaction, product and partner information to facilitate transactions.

As shown in FIG. 1, the MCTP system evaluates the data, performs appropriate calculations and generates one or more offers to one or more members. The calculations may include novel calculations to support unique goals achievable by the disclosed process and apparatus. For example, the system may have access to or store within its memory a listing of members for partners by class. For example, one class of members may be those whose membership will expire within a short period (e.g., six months). An example of a second class may be those members having at least a minimum of MCTP system-specific virtual currency (e.g., an amount of at least 2,500). A third example may include those members that have not had a transaction (e.g., offer acceptance, inquiry, etc.) within a minimum period, e.g., twelve months.

The offer generation module of the MCTP system may be configured to generate an offer that may involve consideration of the same information for each member of different groups, but may result in generation of a different offer depending on which group the member belongs. Additionally, the yield/pricing engine works with the offer generation module to generate offers generated that provide a specified profit to the MCTP administrator and/or to a client (partner). Thus, the offer generation module of the MCTP system sends one or more offers to one or members and receives acceptances to form booking and/or purchase contracts.

Additionally, as illustrated in FIG. 1, the network interface and the call center interface may be coupled to one another and the other components of the MCTP system and communicate over one or more public and/or private networks, e.g., the Internet, intranets, telecommunications networks, which, in turn, provide communication links to members. The offer generation module (which may also be considered an offer inquiry administration system) receives partner information (prices, availability, etc.), member information, and offer information. The offer generation module cooperates with the yield/pricing engine to calculate prices for offers depending on yields or margins to be generated based on the pricing. In this way, the yield/pricing engine provides the ability to realize margins or yields set by partners with the MCTP system, e.g., a cruise line.

For example, disclosed embodiments can provide additional utility in the cruise sector for members to buy an initial package of virtual currency considered and referred to herein as virtual currency, that can be used toward a cruise line cruises and excursions. For example, members may purchase a pre-determined initial allotment of virtual currency, e.g., ranging from enough currency to fulfill 2-5 vacations (depending on date, itinerary, duration and stateroom type chosen); members can also earn additional virtual currency through the use of shoreside lifestyle club benefits (which may be funded in a number of different ways including from a margin for an underlying transaction, as explained herein) that can only be used on a cruise line cruises and excursions. Members can purchase additional virtual currency to add to their account when needed; the amount of virtual currency required to book a vacation may be derived from converting the underlying price of the cruise to the cash equivalent of virtual currency.

The offer generation module is shown as communicating with the customer via the Internet, however, it is to be understood that communication via mail service (e.g., the U.S. Postal Service), messaging, voice call and other non-Internet communication links is anticipated.

By way of illustration, the present embodiments of the MCTP system provide utility and novelty in that they provide a mechanism for a member the ability to exchange a timeshare week against a cruise that would not be available elsewhere in the conventional marketplace. To support this in a profitable manner, the disclosed embodiments utilize a unique and proprietary technology that optionally manages all aspects of members' memberships, and price/filter/present products in a manner that presents a member value in a renewable membership that gave them access to these benefits and products, while offsetting revenue that came from alternative sources. Disclosed embodiments of the MCTP system may be configured to support all of those variables, including potentially negative margins (if and when such margins are deemed acceptable by the MCTP system and partners).

Disclosed embodiments, for example, may give members access to a variety of benefits, such as the ability to exchange their timeshare week and earn substantial value on a cruise, to rent deposited weeks to other members at low discounts, etc. Products may be available both online and by telephone. The products may be products and services offered to a member created using a database that retrieves, in real time, from an Application Programming Interface (API) feed from a vendor of travel products hotels and cruises.

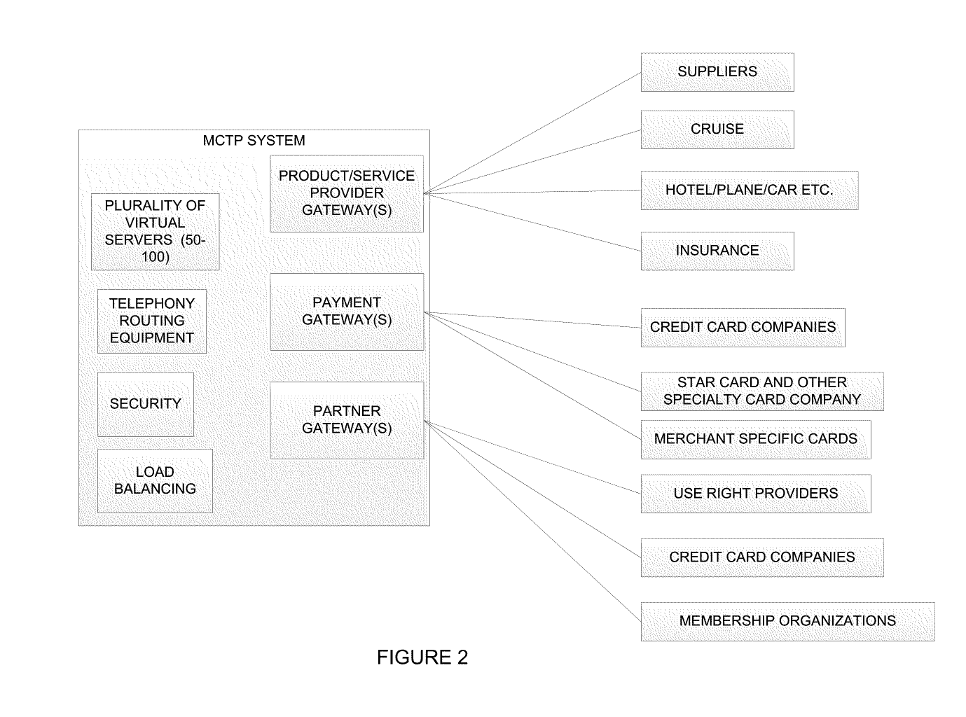

Thus, as illustrated in FIG. 2, the MCTP system and interacts with various organizations including suppliers, cruise lines, hotel/plane and automobile services, insurance, credit card companies, specialty card companies, merchant specific credit card companies, user right providers (e.g., time share organizations) and other membership organizations. As a result, depending on the particular relationship with the MCTP system, these organizations may be partners payment facilitation or processing companies, or product/service providers. Accordingly, these organizations may interact with the MCTP system components through dedicated gateways that may be API based and enable single sign on and virtual currency balance data acquiring and data regarding a member's member segment.

Products and services offered to a member may be created using live API fed data wherein the value of a specific product or service is derived from calculation based on whether amount is cost based or commissionable rate—but has no bearing on consumer price which is simply a data point that may or may not be collected and stored in the yield/pricing engine.

Thus, the yield/pricing engine performs calculations to determine a “margin” (which is another data point, by program type); however, the margin need not be directly translatable to a consumer price because the yield/pricing engine takes the market rate and the MTCP's actual cost for a particular product offering (market rate only used to show consumer expectation of value) as data points in the calculations.

Nevertheless, it should be understood that calculated margin is not the end point for calculation—it is a factor in determining member price for the product. Additionally, the yield/pricing engine calculates a “revenue share” due to an entity other than the member, not based off commercial agreements between the administrator and partner(s), and used only as a data point—it is a factor in determining end member price. A “revenue share” which is an amount due from the MCTP system to a partner is calculated for use in determining the final offer price. However, it should be understood that the revenue share may not be based on a commercial agreement; rather, it may use only as a data point (a factor) for arriving at the final offer.

After determining a product and/or service to be offered to a member, an offer is prepared which shows the member how much can be used in virtual and/or actual currency. The amount may display this as savings—the calculation determines economic value of transaction, which then may determine what a member will see in the offer which includes a request to book the product/service. It should be evident that each offer that is accepted will benefit the MCTP system and at least one or more partners of the MCTP system.

Every member theoretically can see the product at a cost of a different combination of virtual currency plus real currency based on the amount of the virtual currency the member has to use (based on their available balance). The member can ultimately determine how much of each to use (i.e., moving currency payment down which would change cash payment).

Presently disclosed embodiments of the MCTP system provide memberships that may be sold at a wholesale price to partners that have entered into a contractual affiliation with the MCTP system. Under such a contractual affiliation such partners, for example, timeshare resorts, may be required to bundle a membership with every timeshare sale they made. Such a membership can range between one and three years and has an average approximate value of, for example, $250. Pricing to the partners may fluctuate based upon negotiations that encompass a variety of factors.

Two primary sources of utility provided by the disclosed embodiments are the ability to demonstrate enough value in the membership to members to achieve an effective sales level for partners and to provide enough value post membership sale to encourage the member to renew or extend their membership with the partner and/or MCTP at the end of an initial period.

Thus, for example, a plurality of partners, e.g., merchant specific cards, loyalty program administrators or time share resorts, may buy a bundled membership at a reduced price, wherein members may be sorted by the partner and/or the MCTP system into various classes. As a result, if a member called into the MCTP call center or logged into the MCTP website (implemented as part of, for example, the network interface of the MCTP system), interested in exchanging their week against a balcony cabin on a Carnival® 7-day Caribbean cruise, the MCTP system (to price it correctly) may consider a plurality of factors: street rate $2100; minimum exchange value expected by member $600; member pays in cash $1500; cost to MCTP system to buy cruise $1700; staffing/agent commission/service costs $150; system profit/loss on transaction $350. Thus, the $600 discount (minimum exchange value) may be calculated by a yield and pricing engine, taking into account the following factors: amount received for each membership at the resort; percentage of members likely to redeem for a cruise during their initial membership; value of the exchanged week if rented to someone else also factoring a percentage of breakage among deposits; membership renewal/upgrade rate for members at that resort; insurance take-up rates; back-end overrides and co-op funding from Carnival®, etc. Therefore, a separate pro forma for each resort may be established and dynamically tracked, managed and supported.

In addition, adjustments to the rules in the yield/pricing engine enable the MCTP system to automatically make decisions based upon real time data coming from organizations illustrated in FIG. 2 electronically. As a result, the MCTP system may function much more as an arbitrage vehicle than a straight yielding/pricing engine that operates solely on product margin.

As another illustrative example of the utility of the disclosed embodiments, consider Resort Condominiums International (RCI) which was founded in 1974 and now has over three million members. There are RCI resort properties in over 100 countries.

In accordance with the presently disclosed embodiments of the MCTP system, an RCI membership fee need not be shared with the MCTP system to provide revenue to the MCTP system; rather, a portion of the “exchange” fee charged by RCI for every exchange may be received MCTP system instead. Thus, RCI may be paid a small revenue share on certain bookings so as to effectively package the product offering in an attractive way to members and partners alike. Accordingly, the MCTP system supports additional variables and flexibility in the calculation of an RCI package for sale.

In operation, upon receipt of a member request for price information associated with a product or service, the request may be input into the offer generation module which associates relevant data (the assigned grouping of the member, available virtual currency, etc.) One or more offers are then generated in cooperation with the yield/pricing engine to ensure. Optionally, a further review may be made by MCTP system and generated offer(s) may be modified and/or new offer(s) may be added before forwarding a response to the inquiry.

Further, the MCTP system components are capable of generating offers pertaining to an open itinerary product into the market. Such functionality is particularly valuable for, for example, vacation club partner members. Thus, basically, for a fixed price, a member could pre-purchase bundled vacation product (say a cruise and a resort stay, that could be taken separately), that they could redeem any time in the next eighteen months against eligible products. Such product offering are particularly attractive because, if the member has some flexibility, they could literally save thousands of dollars.

To redeem such a product offering, the member may simply visit a branded web site associated with their partner, which would present only inventory that met certain yield and filter rules. Thus, pricing for the product offering would display as “free,” for example, on a cruise, for most popular cabins, with upgrade prices listed for things like mini-suites. Thus, there might be at least two packages with different price points associated with every brand.

This means that the yield/pricing engine takes into consideration additional variables when selecting the inventory eligible to display to the member for redemption, as well as any upgrade pricing, e.g., purchase price of package, sales commissions, revenue share to partner (such as RCI), breakage/non-redemption rate, upgrade frequency/amount, regional variations (e.g., a package might guarantee Alaska or Hawaii sailings would be available, which are typically more expensive). Thus, the yield/pricing engine may be configured to subside and sell at a loss up to a stop limit in some destinations.

In accordance with at least one embodiment, the MCTP system can perform pre-issuance of an amount of the virtual currency, wherein an effect of the pre-issued virtual currency on a transaction is based at least in part on an underlying value of a transaction to which the pre-issued amount of virtual currency are applied. Thus, the yield/pricing engine has been developed to support the pricing and yielding of products in packages via certificates to extend the certificate yield capabilities to support a stand-alone product. Such certificates might be good for $x dollars off a particular product, or even a free product, such as a seven night cruise for two, or a seven night resort stay. Such certificates could be funded in a variety of ways, for example, the discount (or in the case of free product, the total price) may be paid for at a set level based upon rules set for that certificate in the yield/pricing engine (i.e., don't show any cruise cabins with over a $600 cost to the present system). The utility of offering such certificates is at least partially as a lead generation tool or transaction closing incentive wherein partners might use these as lead generation tool. However, in such implementations, the yield/pricing engine may also need to factor in breakage rate on particular groups of certificates, upgrade rates and amounts (if applicable) and amount paid by partners for the certificate.

In accordance with at least one disclosed embodiment, the MCTP system may maintain the ability to outbound sell memberships and package products over the telephone via voice call from call centers. In such an implementation, the MCTP system calculations may rely more heavily on revenue from MCTP system or partner memberships that are sold. Thus, in such an implementation the MCTP system may generate leads for memberships that are outside the timeshare market.

For example, the MCTP system may identify frequent cruisers for potential participation in a cruise loyalty program. In such an implementation, the system may have deals with retailers in major port destinations to give away complimentary one year memberships, as well as virtual currency, to any cruiser who purchased products in their shop. In at least one implementation, the virtual currency may carry no cash value; however, since there is just one variable in the formula, the MCTP system can set discounts and subsidize products based upon the revenue earned from conversion of those members into a more expensive or extended membership tier (or sell them a package product). Thus, as members buy product, they earn more points, but they need an active membership to redeem them; thus, the configuration promotes renewals and upgrades. In such an implementation, from a technology perspective, points (whatever their value) can be used as a variable in setting pricing, even if it is just to support price points that enable a membership sale. This enables the MCTP to treat the points (or miles, or whatever the partner chose to label their loyalty or reward currency) as if they carry value, both from a ‘buy’, ‘sell’, and a buy-back perspective. As a result, the partner's virtual currency can fall into one of three buckets: non-funded, partially-funded and fully-funded.

Non-funded virtual currency carry no value, but can be used as a vehicle to offer member value, with discounts and subsidies being based upon the success and volume of membership sales to a user's account.

Partially-funded virtual currency establishes “buying” power rate for the member that is greater than the value that will be reimbursed from the partner (e.g., an airline who offers frequent flier miles). Thus, a member might get $0.50 per mile in spending power, but the airline only reimburses $0.25 cents per mile to the MCTP system. In such an implementation, the yield and pricing engine factors that in, along with the other factors covered above, to determine what product and what price points to show.

There are two types of fully-funded virtual currencies: reimbursed by a partner and funded by the MCTP system).

Fully-funded virtual currency can be fully reimbursed by a partner. That is, the partner (e.g., SOUTHWEST AIRLINES® or AMERICAN EXPRESS®) reimburses the MCTP system in full at the same rate that the MCTP system provided the member in buying power. In this case, because the member is, in effect, paying full retail, the brand revenue can be positive even without potential offsetting revenue (although straight fulfillment brands are less likely to be as profitable as a brand with membership or package sales involved). Alternatively, fully-funded virtual currency that is system funded may be available in some cases by the MCTP system selling packages or memberships that have points as the currency, instead of certificates.

Redemption of virtual currency may be channel agnostic, allowing customers to redeem with their preferred travel agent partner, direct with the cruise line or club fulfillment concierge.

Nevertheless, disclosed embodiments may actually create goodwill and additional marketing opportunities for travel agent network as credit virtual currency may be used with any travel agency. This is because the MCTP system may, with regard to travel agent transactions, utilize funded virtual currency, which enables members to simply redeem their virtual currency as a form of payment. Thus, in at least some implementations, the disclosed embodiments may utility fully funded virtual currency that may act just like a gift card or credit card.

Thus, there need not be any special set up or hassle for a travel agent; to the contrary, travel agents may also benefit from the disclosed embodiments of the MCTP system in that a customer that has pre-committed to future cruise line cruises and has a funded currency that is ready to be redeemed for a cruise without any additional out of pocket expense is more likely to book such cruises. Further, the member can use their travel agent of choice or redeem directly with the club (just as non-club members) Likewise, the travel agent can earn the same commission as if their cruiser had used cash. Thus, disclosed embodiments provide utility to the travel agent community.

Utilizing the disclosed embodiments, cruise lines can sell more shore excursions because vacation club members can use their virtual currency to purchase shore excursions; these are simply a form of currency. The member owns the virtual currency and may choose to utilize their existing virtual currency instead of paying for shore excursions with cash. Members spend more, on average, when using virtual currency than when using cash. As significantly, in accordance with at least one disclosed embodiment, members can only use their virtual currency with a specific cruise line; therefore, members will buy their excursions through that cruise line brand. This is an effective way for cruise lines to compete with third party shore excursion providers. As a result, disclosed embodiments increase both the percentage of guests purchasing excursions with a cruise line brand and their average spend.

There are also various potential variations on the virtual currency approach that involve labelling them as travel dollars or travel rewards (non or partially funded), vacation cash (fully funded), and cash back (fully funded). Some partners might use multiple currencies, even within the same member segment. This is all using the same core concepts and technology components, but just re-labelling and repackaging them.

In at least some implementations, the disclosed embodiments of the MCTP system may be based on membership and package sales, not sales of individual products. The MCTP may be configured to support that primary objective rather than to yield out and make margin on any individual product. This means the MCTP system may be configured to maximize the total brand revenue, with the assumption that the majority of margin in most cases will come from memberships, not product. Whether the yield/pricing engine prices a product at retail, at cost, or below cost is entirely a function of what best maximizes the overall revenue.

Thus, it should be understood that there are an unlimited number of ways for a member to purchase or acquire a product: for example, a complete cash transaction, a combination of cash and trade, cash and points, points only, the product is free with a certificate of redemption, cash and travel dollars, cash back, etc. The MCTP system has the ability to calculate an appropriate product mix such that offers can be presented to potential members.

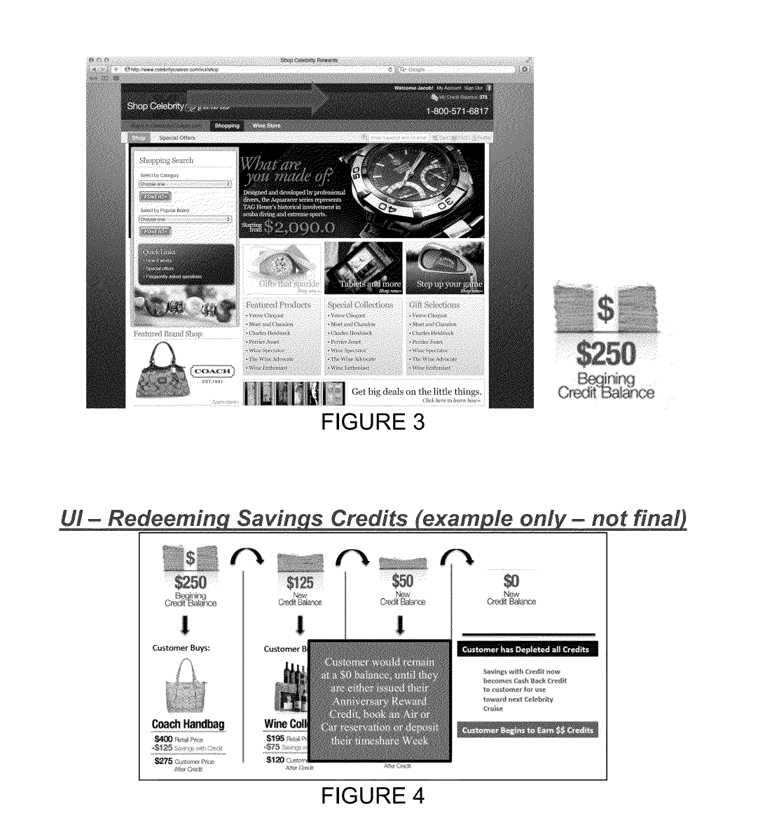

Disclosed embodiments may be applied broadly across various travel related product portfolios including cruises, resorts & tours, full-service travel, and various lifestyle products. FIGS. 3-4 illustrate examples of functionality for providing members with the ability to purchase product offering based on virtual currency/actual currency spent through the MCTP system of the disclosed embodiments.

As shown in FIG. 3, embodiments may be initiated when a member is awarded a currency-based reward issued by a partner in the form of a margin-based “savings credit.” This savings credit can come in the form of a pre-determined or fixed dollar amount, or can be given as a dollar-for-dollar match amount for any defined purchase event. Members may be awarded such credits in response to various events.

For example, a member may receive a margin-based savings credit in response to initial enrollment into a membership program (e.g., by a resort, cruise line or commercial partner); in such a scenario the multi-currency transaction processing system may be configured to seed each new membership account with an initial “savings credit” balance. The amount awarded may vary by partner, sub-partner and/or member class. For example, suppose that a result sells a timeshare to a new prospect and presents the new member with a “savings credit” certificate that automatically seeds their account with $1,200 in savings credits and an initial 2-yr membership term when they activate their membership account.

Alternatively, a savings credit could be issued for a member's MCTP system account for rewarding certain behaviors driven by the MCTP system, a resort, a cruise line or commercial partner. For example, a cruise line customer may purchase a pre-cruise excursion for $500. After they purchase, the cruise line may send them an electronic mail or other communication providing a voucher to activate a $500 savings credits that is then activated through the MCTP system. As another example, the MCTP system may issue a bonus savings credit as a month-end membership promotion for purchasing a MCTP membership upgrade, or by a resort for the member paying their maintenance fee early, etc.

Still further, a savings credit could be issued for a member's MCTP system account on the anniversary of the member's enrollment date or purchase date with the MCTP system. In such a scenario the MMCTP system may deposit an “anniversary savings credit” into a member's MCTP membership account. For example, if a member received a free 2-yr trial, but has not yet upgraded, this savings credit might only be applied on the second year of their initial free 2-year trial; further, if within the 2-yr trial the member paid for a membership upgrade, they might receive their anniversary savings credit each year on the date of their initial upgrade purchase.

Moreover, savings credits may be issued by the MCTP system when a member makes air or car reservations online or by phone through their MCTP membership, they may earn a savings credit reward for a pre-determined amount. The amount could vary by partner, sub-partner and/or member class. For example, a resort member may shop online looking to book a car rental reservation. During the search and checkout process, they may be displayed an opportunity to earn a $100 in savings credits for making the reservation through their resort. As a result, the savings credit may be automatically added to their MCTP account for each transaction; that addition may be made either on a pre-travel or post-travel basis.

Still further, savings credits may be issued to members' MCTP system accounts in response to the members depositing their timeshare week for either a cruise or tour exchange. In accordance with at least this particular embodiment, savings credits may be combinable with various other types of virtual currency and cash to purchase products/services.

In accordance with at least this particular embodiment, savings credit balances may be displayed on a website (which may be a fully-branded redemption website) acting as a front end Graphical User Interface (GUI) to the MCTP system for members. In this way, members can track the credit account balance on a real-time basis as it is used by the member. For example, this may be implemented by displaying that data on a “My Account” page specific to the member, which may also include a description of what they earned the savings credit balance for (e.g., initial enrollment, week deposit, anniversary, air/car booking, etc.) and when it expires/or if it has expired. This enables member to know what their available balance is as they shop through the website and during a checkout process.

After a saving credit award has been awarded and registered and the member account is established in the system, the member is able to login to the website to use their earned savings credit balance. As shown in FIG. 4, upon login, the member may be able to see their registered credit balance and be able to shop within one or more product stores across any and all of the enabled product stores for cruises, resorts and tours, full-service travel and a range of lifestyle products. The redemption stores may also be configured by partner to include all or just a limited subset of the available product stores that the MCTP has to offer. Some partners may choose to only enable the reward credit balance for redemption against a subset of available products, e.g., wine and shopping, while other partners may desire the full product offering be available.

In accordance with at least this embodiment, members will see a “savings credits” (represented in the form of ($) dollars) off a purchase price of any particular product as they shop online within each of the travel and lifestyle product categories. This savings credit automatically declines with each purchase made until the savings credit balance is extinguished. As mentioned above, savings credits are margin-based. As a result, savings credits have a variable value depending on what product offering is being purchased with them, how many savings credits are being used in a transaction, and/or the margin value associated with the transaction.

Further, it should be understood that the term “margin value” refers to a numerical value for a particular product offering that may signify the amount of profit that purchase of that product offering will generate for the MCTP system. As a result, calculation of the margin value requires determination or data indicating the cost of the product offering to the MCTP system along with selection of a price to charge a user for the purchase of the product offering. For example, with regard to a cruise product margin calculation, margin value is the variance between the cost of the cruise for the MCTP system and the price of the cruise published by the MCTP system. In implementation, the margin value may be the cost to MCTP to acquire the inventory cruise product offering and the lowest, available, unrestricted cost/fare in the retail marketplace (the term “unrestricted” referring to fares without special qualifications for age in the case of Senior Rates, state residency for special resident rates, past passenger discounted rates, etc.)

In accordance with at least this embodiment, a savings credit balance may optionally be utilized in a partial pay configuration on every individual transaction. This means that the member may use a combination of a portion of their savings credit balance and “cash” towards every purchase.

In accordance with at least this embodiment, on any given transaction made within a store, the amount of the savings credit balance used may be variable and based upon the margin characteristics of each individual purchase. Therefore, a greater amount of credit balance may be used on one product purchase over another. The member may be able to see the amount of credit that is available to use on every purchase upfront in the online shopping experience. This enables them to shop in confidence with competitive market pricing and a best rate guarantee knowing upfront how much of their credit balance they can apply on any given product before they buy.

In accordance with at least this embodiment, savings credits may be redeemed from the oldest buckets first (i.e. so that expiring savings credits are being used up before credits that were issued with newer expiration dates). In accordance with at least this embodiment, in the event of cancellation, savings credits may be reallocated back to an original bucket and expiration date. Cancellation rules for savings credits may vary by product category based on cancellation policies.

As shown in FIG. 4, the member shopping experience is very straight forward and easy to follow.

Various disclosed embodiments of the MCTP system and processes provide a technically specific solution to (1) convert a variety of partner-specific points/loyalty program credits for users to a MTCP single virtual currency and (2) support transactions for users for services/products from various vendors/suppliers using a combination of the virtual currency and real currency. Thus, the disclosed MCTP embodiments create and utilize member profiles and provide members the ability to combine their use of actual currency and virtual currency created by a travel partner using common virtual currency to obtain a product and/or service available from a wide variety of vendors. Further, the use of common virtual currency enables formulation, management, comparison and presentation of options for using virtual currency specific to travel partners.

Further, disclosed embodiments may utilize a yield/pricing engine that dynamically sets a permitted mix of real and virtual currencies for a specific transaction. That permitted mix may be allocated per member, per member class, and/or per client associated with the member class. Disclosed embodiments may dynamically set the permitted mix based on a member's valuation and/or client value within the system and based on market conditions.

Moreover, in accordance with at least one embodiment, the MCTP system can perform accelerated conversion of funded points, wherein an effect of the converted funded points on a transaction is based at least in part on an underlying value of a transaction to which the converted funded points are applied.

Disclosed embodiments of the yield/pricing engine have the ability to formulate one time or periodic, e.g., monthly, sales of products and services in a private manner to the members associated with a particular partner; in such sales, the members have the ability to apply the full or partial balance of their savings credits toward a featured selection of travel and lifestyle products. Each of the products available in the sale may have set quantities that range from four of each product to nearly forty of each product. Each sale may include offerings for, for example, approximately 350 products.

The yield/pricing engine formulated sale may offer two redemption types to members in order to redeem their savings credits. Full Redemption may be available for products that members may apply their savings credits towards the full market price of the product. Full redemption products may be released for sale to members, for example, every 15 minutes throughout the sale time period, e.g., four, six, twelve or twenty four hours, for members to purchase. Alternatively, 50/50 Redemption products enable members to apply their savings credits to 50% of the product price. 50/50 Redemption products may be, for example, available throughout the entire sale time period for members to purchase.

During such sales, product offerings may be purchased on a first-come, first-served basis only. Once an offer or sale product is sold out, it is no longer available.

Utility is provided to the MCTP system and its partners because it provides not only a member benefit for the partner's members but also provides additional revenue share opportunities above and beyond transactions paid for via regular currency, e.g., cash and a combination of regular currency and partner-specific currency funded transactions.

To communicate the existence of the member benefit, qualifying members may receive a communication, e.g., electronic-mail, text, voice call, etc. at some period prior to the sale starting. Such a communication will notify the member that they can take part in a sneak-peek′ of the sale so members can determine which products they'd like to try and claim during the sale. For example, for travel offers, the preview may enable members to review their calendar to see if the dates work for their schedule as well as review and compare airfare prices.

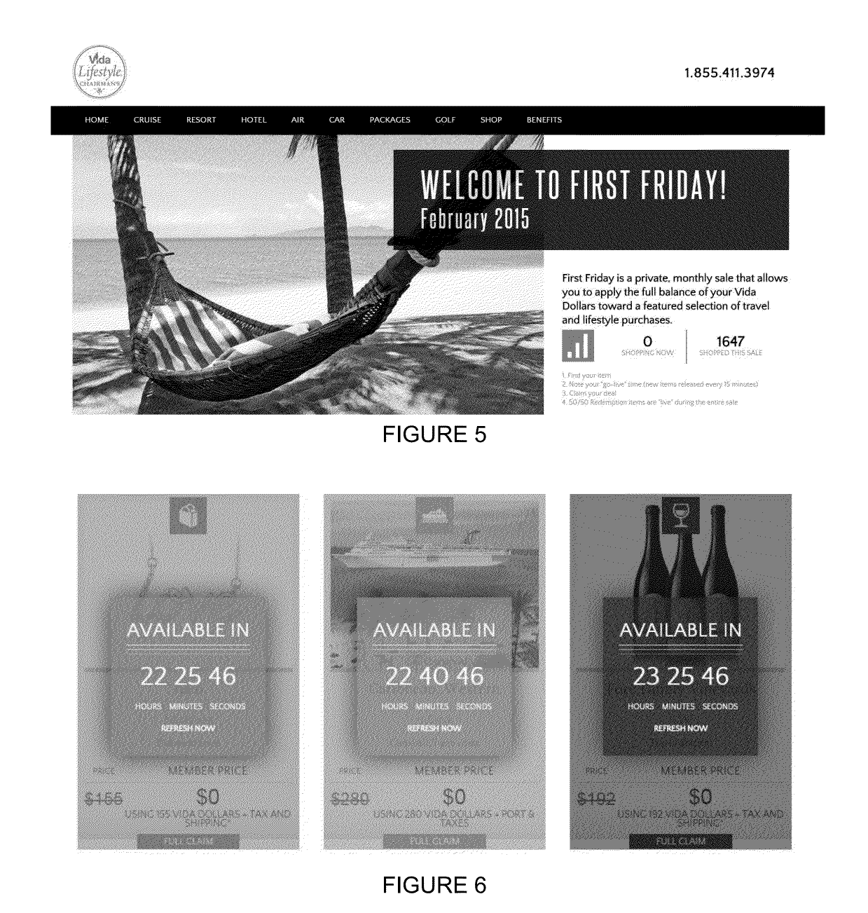

During the sale, members may access a sale page provided on the MCTP system website or a partner's branded website. FIGS. 5-11 illustrate various examples of screen shots associated with the front end of the MCTP system, and in particular, the yield/pricing engine and the offer generation module, providing this functionality. FIG. 5 illustrates one example of a potential configuration for such a sale page on a partner's branded website. That sale page may include, for example, a welcome message, instructions on how to shop the sale, and the number of other members shopping the sale vs. the number of members that have shopped the sale thus far. The page may also include a “Shopped This Sale” field, which provides an indication of the popularity of the sale and conveys an understanding of the significance of purchasing a product in the same way that seeing checkout lines in a store for a popular sale affects a purchaser or prospective purchaser.

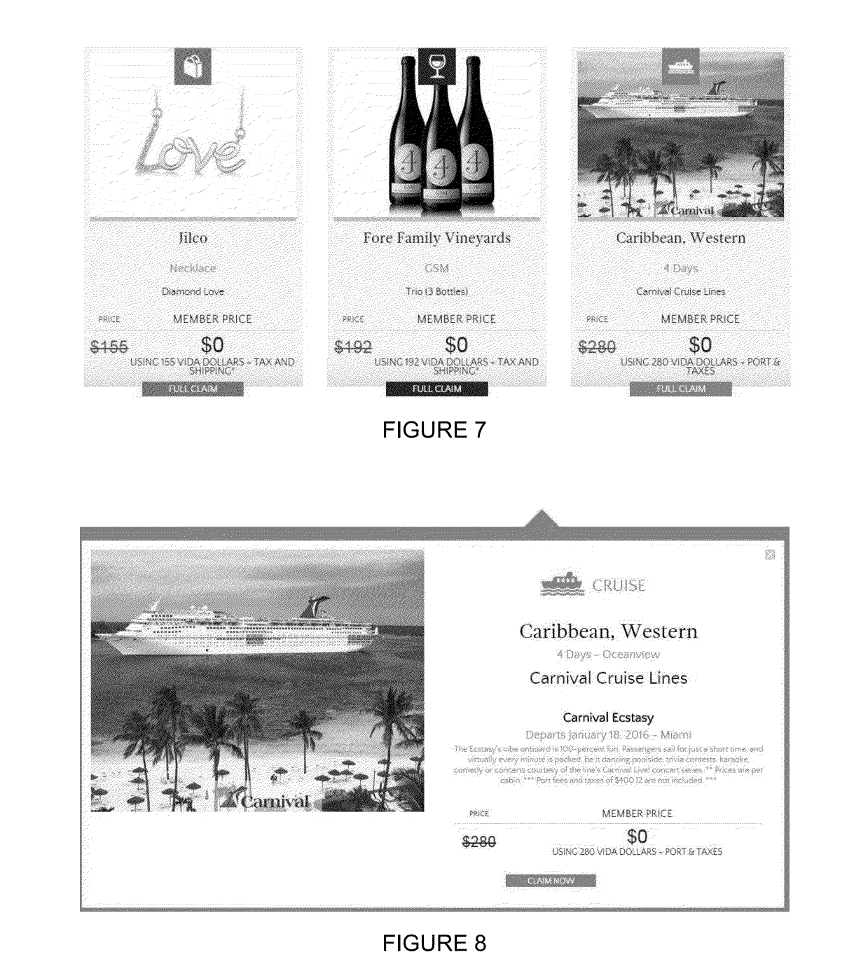

When members come to the page prior to the sale, they may view displayed images of products (for example, see FIG. 6) that will be available during the sale along with a count-down until the product will be live and able to be purchase. When the products are available for purchase, the countdown overlay may disappear to indicate that the products are available for purchase (for example, see FIG. 7). Subsequently, members have the ability to click the ‘Full Claim’ or ‘50/50 Claim’ buttons to see expanded offer details including a description of the travel or lifestyle product (for example, see FIG. 8).

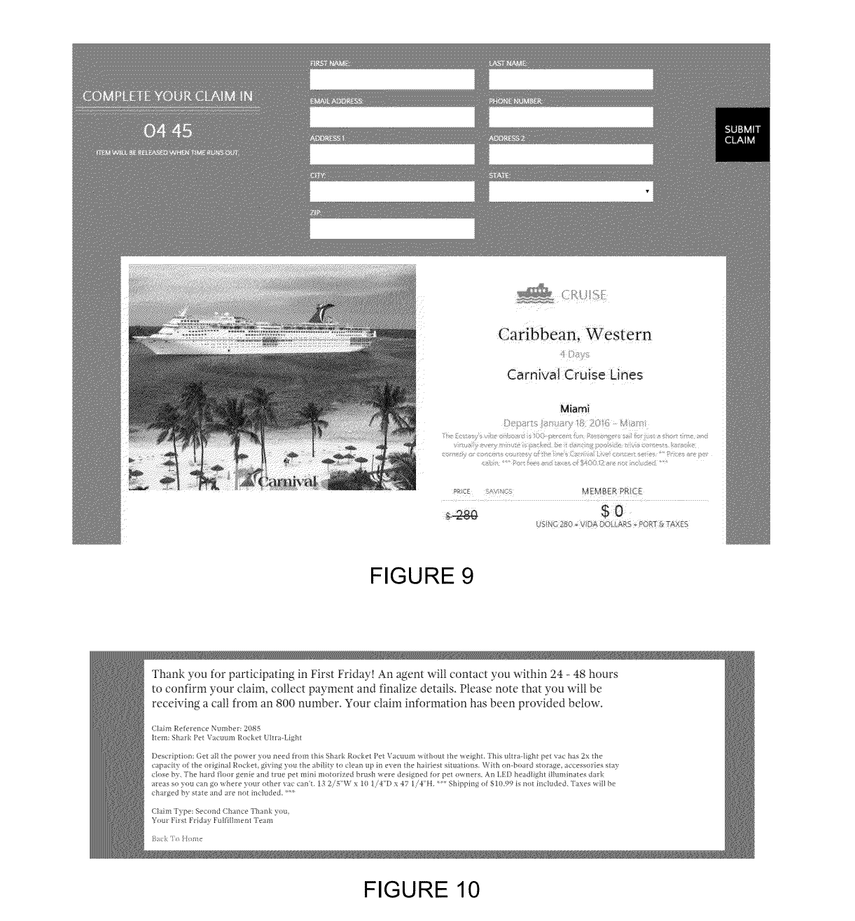

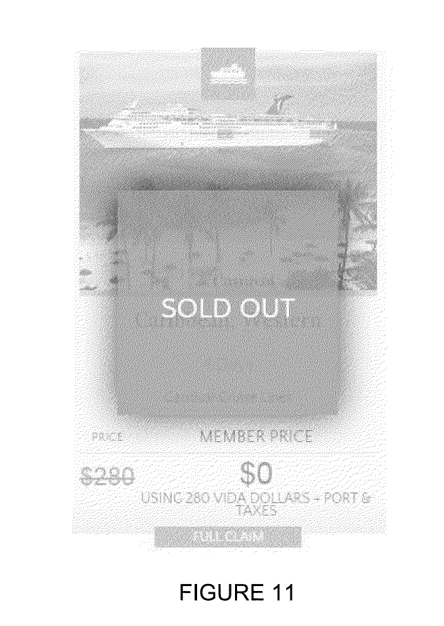

From that expanded view, the member can click the ‘Claim Now’ button which may direct the member to a claim form (for example, see FIG. 9) with a specific timer indicating a time period until the product is released back into the pool of available product for members to purchase. Once the member has claimed a product, they may receive a confirmation message on the website (e.g., FIG. 10) as well as a communication, e.g., electronic mail, text, voice call, etc. with their claim number. Once the available quantity of a product has been purchased, the product will show a Sold Out overlay (see for example, FIG. 11) so that other members aren't able to purchase the product.

The yield/pricing engine enables administrators of the MCTP system sale to receive and review real-time reporting data where they can see which members have claimed which products and when products have been sold-out. If needed, administrators can also update the quantity of a product during the live sale.

In accordance with at least one embodiment, the MCTP system can be utilized to incentivize a member to pay their partner maintenance fee/member dues by effectively reimbursing the member for maintenance fees/member dues based on payment of the maintenance fees/member dues paid to the partner. The reimbursement may be in the form of the MCTP systems virtual currency. Funding of this reimbursement may be made in the same manner as explained above, for example, non-funded, partially-funded, or fully-funded. In such an implementation, an effect of the virtual currency on a transaction performed on the MCTP system may be based at least in part on an underlying value of a transaction to which the virtual currency are applied.

In accordance with at least one embodiment, the MCTP system may be configured to provide benefits to members that participate in shoreside benefits of the program as well. For example, a member who purchases cruises can increase the member's balance of virtual currency by purchasing other products not strictly associated with their cruise resort packages, travel, merchandise, wine etc.).

Additionally, the MCTP system may be configured to enable members to use some portion or all of their virtual currency to purchase products and services while in port on their cruise with cooperating partners of the cruise line, e.g., jewelry and luxury brand retailers. By using the yield/pricing engine, the MCTP is able to dynamically set a permitted mix of real and virtual currencies for a specific transaction, whether it be for services or products provided that the MCTP system has data associated with a required minimum or acceptable underlying margin and/or yield. That permitted mix may further be determined based on an allocation per member, per member class, and/or per client (e.g., cruise line) associated with the member class. Disclosed embodiments may dynamically set the permitted mix based on a member's valuation and/or client value within the system and based on market conditions.

As a result, the member gains virtual currency while purchasing a variety of products and services, wherein that virtual currency can, in turn, lead to utility for the cruise line by accelerated cruise bookings, upgraded cabin staterooms, increased onboard spend and overall base loading raising stateroom prices and the overall per diem per passenger.

Additionally, the disclosed embodiments may provide additional utility by incentivizing cruisers through referral programs which allow members to earn rewards for referring friends and family to become a member of the a cruise line vacation club or the like.

It should be understood that, although disclosed embodiments utilize software algorithms, the inventive concept is directed to processes and machines that require the use of such software algorithms in order to provide novel functionality. Thus, the disclosed embodiments are fundamentally more than the mere integration of building blocks of human ingenuity because the disclosed embodiments provide improvements in the travel service industry, which in the last 25 years has become completely dependent on computerized booking systems. Although the disclosed embodiments utilize mathematical relationships, the inventive concept builds upon these mathematical relationships to provide a system that utilizes virtual currency so as to enable coordination of disparate currency and points based, computerized reward systems to determine product/service offerings for presentation to members in a comparable and understandable way.

Additionally, although the disclosed embodiments improve upon conventional economic practices associated with the purchase of products and services, the disclosed embodiments provide this improvement as a result of a technological innovation that has no analogy in the conventional travel industry. This is because the disclosed embodiments enable the improvement of the functioning of the computerized booking systems themselves in that the virtual currency enables interaction and management of communication between disparate booking systems and points based, computerized, reward systems. Therefore, the disclosed embodiments provide functionality and features that are meaningful limitations beyond the mere use of computers in the travel booking industry.

There are numerous variations and equivalents of the disclosed embodiments that should be appreciated by those skilled in the art. The disclosed embodiments are intended to encompass those equivalents and variations.

1. A method for providing cruise packages to a user, the method comprising:
providing a computer system;
identifying at least one type of virtual currency created by a partner and virtual currency created by an administrator;
receiving a request from a user over at least one communication network for price information regarding a product or service;
ascertaining the amount of actual currency, partner virtual currency and administrator virtual currency needed to purchase the product/service offer;
calculating, using the computer system, a margin value of each offer;
responding to the request for price information over the at least one communication network by forwarding the offer responsive to the request;
enabling the user to choose relative amounts of actual currency, partner virtual currency and administrator virtual currency for the offer responsive to the request;
receiving the user's acceptance of an offer over the at least one communication network and reserving the product and/or service requested with payment in the form of at least one of actual currency, partner virtual currency and administrator virtual currency;
booking the product and/or service identified in the accepted offer;
updating the computer system records to reflect the payment received; and
confirming, by the computer system, the amount of margin available and allocating a portion of the margin to administrator equity.

2. The method of claim 1, wherein the partner virtual currency is non-funded, partially funded or fully funded by the partner.

3. The method of claim 1, comprising
receiving partner virtual currency with payment from the partner to the administrator for acceptance by the administrator for use of the partner virtual currency in a transaction with a user.

4. The method of claim 1, comprising:
allocating virtual currency to a user's account based on the user's acceptance of the offer, and tracking by computer the amount of available virtual currency for the user.

5. The method of claim 1, wherein a value of partner virtual currency and/or administrative virtual currency for an offer is margin based and specific to that offer.

6. The method of claim 1, wherein the partner is at least one of a resort time share organization, loyalty program, private-branded payment or membership organization, leisure-based membership organization, or reward program.

7. The method of claim 1, wherein at least one product in the accepted offer is a cruise.

8. A system that provides cruise packages to a user, the system comprising:
a computer system running software code that identifies at least one type of virtual currency created by a partner and virtual currency created by an administrator and receives a request from a user over at least one communication network for price information regarding a product or service;
wherein the computer system ascertains the amount of actual currency, partner virtual currency and administrator virtual currency needed to purchase the product/service offer and calculates a margin value of each offer;
wherein the computer system responds to the request for price information over the at least one communication network by forwarding the offer responsive to the request and enables the user to choose relative amounts of actual currency, partner virtual currency and administrator virtual currency for the offer responsive to the request,
wherein the computer system receives the user's acceptance of an offer over the at least one communication network and reserving the product and/or service requested with payment in the form of at least one of actual currency, partner virtual currency and administrator virtual currency and books the product and/or service identified in the accepted offer as well as updates computer system records to reflect the payment received, and confirms the amount of margin available and allocating a portion of the margin to administrator equity.

9. The system of claim 8, wherein the partner virtual currency is non-funded, partially funded or fully funded by the partner.

10. The system of claim 8, wherein the computer system receives partner virtual currency with payment from the partner to the administrator for acceptance by the administrator for use of the partner virtual currency in a transaction with a user.

11. The system of claim 8, wherein the computer system allocates virtual currency to a user's account based on the user's acceptance of the offer, and tracking by computer the amount of available virtual currency for the user.

12. The system of claim 8, wherein a value of partner virtual currency and/or administrative virtual currency for an offer is margin based and specific to that offer.

13. The system of claim 8, wherein the partner is at least one of a resort time share organization, loyalty program, private-branded payment or membership organization, leisure-based membership organization, or reward program.

14. The system of claim 8, wherein at least one product in the accepted offer is a cruise.
